(19) United States
(12) Patent Application Publication
(10) Pub. No.: US 2013/0333388 A1
(43) Pub. Date: Dec. 19, 2013

(54) COMBUSTOR LINER COOLING ASSEMBLY FOR A GAS TURBINE SYSTEM

(71) Applicants: Venugopal Polisetty, Bangalore (IN); Sridhar Venkat Kodukulla, Bangalore (IN)

(72) Inventors: Venugopal Polisetty, Bangalore (IN); Sridhar Venkat Kodukulla, Bangalore (IN)

(73) Assignee: GENERAL ELECTRIC COMPANY, Schenectady, NY (US)

(21) Appl. No.: 13/495,674

(22) Filed: Jun. 13, 2012

(51) Int. Cl. F02C 7/18

(52) U.S. Cl. 60/752

(57) ABSTRACT

A combustor liner cooling assembly for a gas turbine system includes a combustor liner defining a combustor chamber. Also included is a flow sleeve surrounding at least a portion of the combustor liner, wherein the flow sleeve includes at least one aperture row comprising a plurality of apertures, each of the plurality of apertures impinging a cooling flow jet onto the combustor liner. Further included is a plurality of flow redirecting components disposed proximate an aft end of the flow sleeve, wherein the plurality of flow redirecting components divert an impingement cross-flow flowing relatively perpendicular to the cooling flow jet, thereby providing the cooling flow jet an undisturbed flow path to the combustor liner.

### BACKGROUND OF THE INVENTION

The subject matter disclosed herein relates to gas turbine systems, and more particularly to a combustor liner cooling assembly.

A combustor section of a gas turbine system typically includes a combustor chamber disposed relatively adjacent a transition piece, where a hot gas passes from the combustor chamber through the transition piece to a turbine section. At least a portion of the combustor chamber is often surrounded by a flow sleeve, while at least a portion of the transition piece is surrounded by an impingement sleeve. The flow sleeve typically includes a plurality of apertures for providing impingement cooing for portions of a liner of the combustor. An additional airflow passes from a region defined by the impingement sleeve and the transition piece to a region defined by the flow sleeve and the combustor liner. The impingement cooling of the liner of the combustor is achieved by cooling jets that are pushed onto the liner in a direction relatively perpendicular to the additional airflow flowing from the region proximate the impingement sleeve to the region proximate the flow sleeve. The additional airflow often disrupts the cooling jets, thereby resulting in reduced cooling efficiency.

### BRIEF DESCRIPTION OF THE INVENTION

According to one aspect of the invention, a combustor liner cooling assembly for a gas turbine system includes a combustor liner defining a combustor chamber. Also included is a flow sleeve surrounding at least a portion of the combustor liner, wherein the flow sleeve includes at least one aperture row comprising a plurality of apertures, each of the plurality of apertures impinging a cooling flow jet onto the combustor liner. Further included is a plurality of flow redirecting components disposed proximate an aft end of the flow sleeve, wherein the plurality of flow redirecting components divert an impingement cross-flow flowing relatively perpendicular to the cooling flow jet, thereby providing the cooling flow jet an undisturbed flow path to the combustor liner.

According to another aspect of the invention, a combustor liner cooling assembly for a gas turbine system includes a combustor liner defining a combustor chamber. Also included is a flow sleeve surrounding at least a portion of the combustor liner and having an aft end, wherein the flow sleeve includes a plurality of apertures for impinging a plurality of cooling flow jets onto the combustor liner. Further included is an impingement sleeve disposed proximate the aft end of the flow sleeve, wherein an impingement flow path is defined by the impingement sleeve and a transition duct, wherein an impingement cross-flow flows through the impingement flow path into a region between the flow sleeve and the combustor liner. Yet further included is a plurality of flow redirecting components disposed proximate the aft end of the flow sleeve, wherein the plurality of flow redirecting components divert the impingement cross-flow.

According to yet another aspect of the invention, a combustor liner cooling assembly for a gas turbine system includes a combustor liner defining a combustor chamber. Also included is a flow sleeve surrounding at least a portion of the combustor liner and having an aft end, wherein the flow sleeve includes a plurality of aperture rows, wherein each of the plurality of aperture rows comprises a plurality of apertures extending circumferentially around the flow sleeve, wherein each of the plurality of apertures impinges a cooling flow jet onto the combustor liner. Further included is a plurality of flow redirecting components disposed on a forward sleeve located proximate the aft end of the flow sleeve and a forward end of an impingement sleeve, wherein each of the plurality of flow redirecting components is circumferentially aligned with a corresponding first row aperture for diverting an impingement cross-flow entering a region between the flow sleeve and the combustor liner proximate the aft end of the flow sleeve.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a partial schematic illustration of a combustor section of a gas turbine system;

FIG. 2 is an enlarged view of section II of FIG. 1, illustrating a combustor liner cooling assembly;

FIG. 3 is a perspective view of a plurality of flow redirecting components of the combustor liner cooling assembly;

FIG. 4 is an enlarged, perspective view of a flow redirecting component of the plurality of flow redirecting components of a first embodiment;

FIG. 5 is a cross-sectional view of a flow profile proximate the flow redirecting component of the first embodiment of FIG. 4;

FIG. 6 is a perspective view of the flow redirecting component of a second embodiment;

FIG. 7 is a perspective view of the flow redirecting component of a third embodiment;

FIG. 8 is a perspective view of the flow redirecting component of a fourth embodiment;

FIG. 9 is a perspective view of the flow redirecting component of a fifth embodiment; and

FIG. 10 is a perspective view of the flow redirecting component of a sixth embodiment.

The detailed description explains embodiments of the invention, together with advantages and features, by way of example with reference to the drawings.

### DETAILED DESCRIPTION OF THE INVENTION

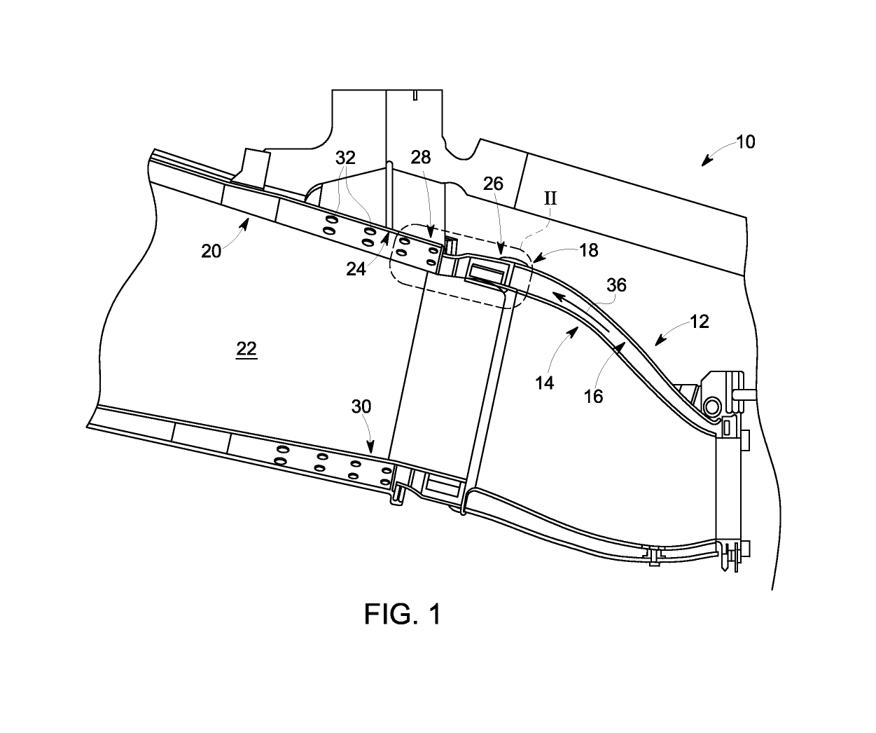

Referring to FIG. 1, partial schematic illustrates a combustor section of a gas turbine system and is referred to generally with numeral 10. The combustor section 10 includes a transition piece 12 having a transition duct 14 at least partially surrounded by an impingement sleeve 16 disposed radially outwardly of the transition duct 14. Upstream thereof, proximate a forward end 18 of the impingement sleeve 16 is a combustor liner 20 defining a combustor chamber 22. The combustor liner 20 is at least partially surrounded by a flow sleeve 24 disposed radially outwardly of the combustor liner 20. A forward sleeve 26 is located at the junction between the forward end 18 of the impingement sleeve 16 and an aft end 28 of the flow sleeve 24.

The combustor section 10 uses a combustible liquid and/or gas fuel, such as a natural gas or a hydrogen rich synthetic gas, to run the gas turbine system. The combustor chamber 22 is configured to receive and/or provide an air-fuel mixture, thereby causing a combustion that creates a hot pressurized exhaust gas. The combustor chamber 22 directs the hot pressurized gas through the transition piece 12 into the turbine section (not illustrated), causing rotation of the turbine section. The presence of the hot pressurized exhaust gas increases the temperature of the combustor liner 20 surrounding the combustor chamber 22, particularly proximate a downstream end 30 of the combustor liner 20. To overcome issues associated with excessive thermal exposure to the combustor liner 20, a plurality of apertures 32 within the flow sleeve 24 are arranged to provide impinged air in the form of a plurality of cooling jets 34 onto the combustor liner 20. The plurality of apertures 32 may optionally include “thimbles” (not illustrated) which protrude toward the combustor liner 20, providing an enclosed region to deliver the plurality of cooling jets 34 toward the combustor liner 20. An impingement cross-flow 36 flows relatively perpendicularly to the plurality of cooling jets 34 and provides a convective cooling effect on the combustor liner 20 while flowing from downstream to upstream along the combustor liner 20. Specifically, the impingement cross-flow 36 flows from a region defined by the impingement sleeve 16 and the transition duct 14 to a region defined by the flow sleeve 24 and the combustor liner 20.

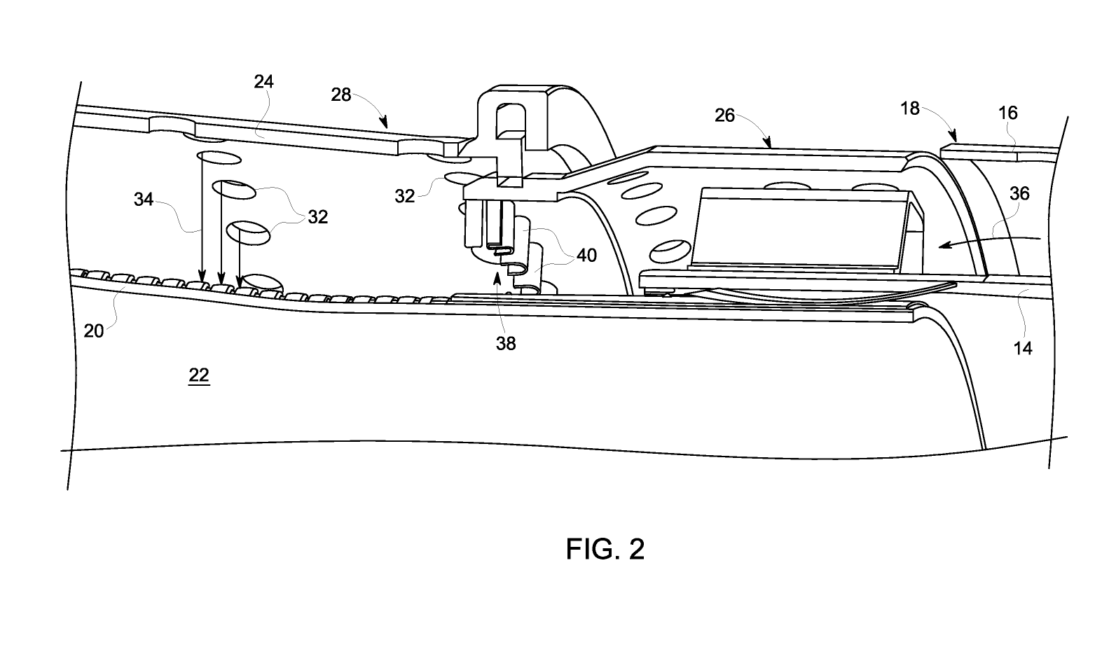

Referring to FIG. 2, an enlarged view of the aft end 28 of the flow sleeve 24, the forward sleeve 26 and the forward end 18 of the impingement sleeve 16 is shown in greater detail. The plurality of apertures 32 within the flow sleeve 24 may be arranged in one or more circumferential rows proximate the aft end 28 of the flow sleeve 24. The forward sleeve 26 includes at least one, but typically a plurality of flow redirecting components 38 operably coupled thereto that are disposed along an inner surface of the forward sleeve 26 in a circumferentially spaced arrangement. The plurality of flow redirecting components 38 may be integrally formed with the forward sleeve 24 or may be fastened thereto. Each of the plurality of flow redirecting components 38 includes a flow redirecting surface 40 that is arranged to interact with the impingement cross-flow 36 that is flowing upstream toward the combustor liner 20 and the flow sleeve 24. Each of the plurality of flow redirecting components 38 is relatively circumferentially aligned with at least one of the plurality of apertures 32.

Although the plurality of flow redirecting components 38 are described above and illustrated as being operably coupled to the forward sleeve 26, it is contemplated that alternative embodiments may include operable coupling of the plurality of flow redirecting components 38 to the impingement sleeve 16 proximate the forward end 18 thereof Additionally, it is contemplated that the plurality of flow redirecting components 38 may be operably coupled to the aft end 28 of the flow sleeve 24, provided that the plurality of flow redirecting components 38 are disposed downstream of the plurality of apertures 32.

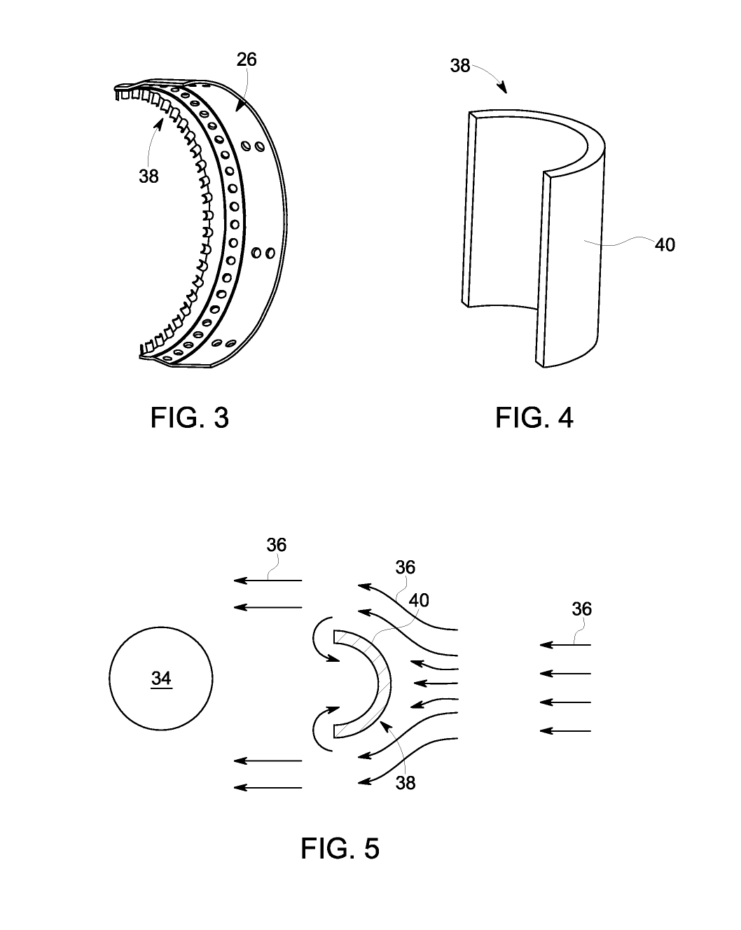

Referring to FIGS. 3-5, a first embodiment of the plurality of flow redirecting components 38 comprises a semi-circular geometry, with the flow redirecting surface 40 arranged to interact with the impingement cross-flow 36, as described above. As the impingement cross-flow 36 interacts with the flow redirecting surface 40, the impingement cross-flow 36 is diverted around the flow redirecting surface 40. As noted above, the plurality of flow redirecting components 38 are relatively aligned with the plurality of apertures 32, and therefore also the plurality of cooling jets 34 flowing relatively perpendicularly to the impingement cross-flow 36. By diverting the impingement cross-flow 36, a disturbance of each of the plurality of cooling jets 34 is reduced based on the lack of a direct interaction between the impingement cross-flow 36 and the plurality of cooling jets 34, thereby allowing the plurality of cooling jets 34 to more efficiently cool the combustor liner 20. Additionally, the diversion of the impingement cross-flow 36 increases the average velocity of the impingement cross-flow 36, which increases the convective heat transfer associated with the flowing of the impingement cross-flow 36 over the combustor liner 20.

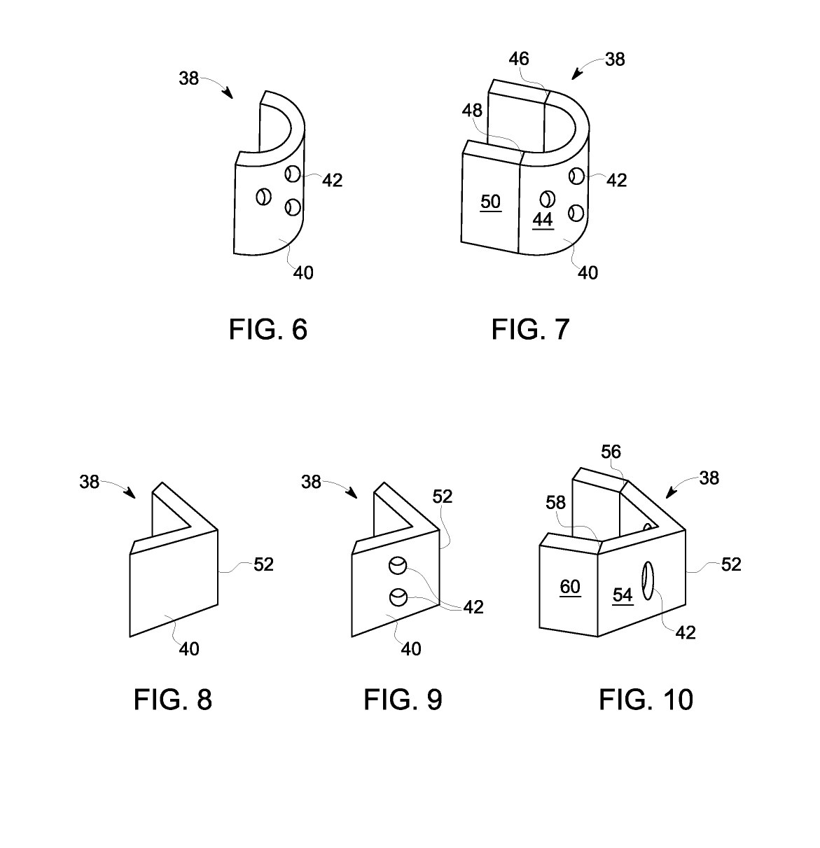

Referring now to FIG. 6, a second embodiment of the plurality of flow redirecting components 38 is shown and is similar in construction to that of the first embodiment illustrated in FIGS. 3-5. Specifically, the second embodiment of the plurality of flow redirecting components 38 includes a plurality of holes 42 for reducing the formation of vortices upon recirculation of the impingement cross-flow 36 subsequent to passing the flow redirecting surface 40.

Referring to FIG. 7, a third embodiment of the plurality of flow redirecting components 38 is illustrated and is similar in construction to the embodiments described above. The third embodiment of the plurality of flow redirecting components 38 includes a first portion 44 having the previously described semi-circular geometry, which includes the flow redirecting surface 40 terminating in a first end 46 and a second end 48. Extending axially upstream from at least one of the first end 46 and the second end 48 is a second portion 50 that provides additional axial structure for the impingement cross-flow 36 to flow along. The additional structure provided by the second portion 50 reduces the axial space between the plurality of flow redirecting components 38 and the plurality of cooling jets 34, thereby reducing the likelihood of the impingement cross-flow 36 disrupting the plurality of cooling jets 34. The third embodiment is illustrated with the plurality of holes 42 described above in relation to the second embodiment, however, it is to be appreciated that the third embodiment may include the second portion 50, but not the plurality of holes 42.

Referring now to FIGS. 8-10, additional embodiments of the plurality of flow redirecting components 38 are illustrated. The additional embodiments are similar to the embodiments described above, but rather than a semi-circular geometry, the additional embodiments include a triangular geometry. Specifically, a fourth embodiment (FIG. 8) of the plurality of flow redirecting components 38 includes a triangular geometry having a flow redirecting peak 52 arranged to interact with the impingement cross-flow 36, as described above with respect to the flow redirecting surface 40 of the semi-circular embodiments. Additionally, a fifth embodiment (FIG. 9) includes the plurality of holes 42. As is the case with the embodiments described above containing the plurality of holes 42, the plurality of holes 42 may be disposed at various angles and in various numbers and shapes and will be dependent upon the application of use. A sixth embodiment (FIG. 10) includes a first triangular portion 54 extending from the flow redirecting peak 52 to a first end 56 and a second end 58, where at least one second portion 60 may extend therefrom, similar to the third embodiment described above. As is the case with the third embodiment, although illustrated with the plurality of holes 42, it is to be appreciated that the sixth embodiment may include the at least one second portion 60, but not the plurality of holes 42. The plurality of flow redirecting components 38 are described above as having particular geometric shapes, however, it is to be understood that any suitable geometric shape capable of diverting the impingement cross-flow 36 may be employed as the plurality of flow redirecting components 38.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustor liner cooling assembly for a gas turbine system comprising:
a combustor liner defining a combustor chamber;
a flow sleeve surrounding at least a portion of the combustor liner, wherein the flow sleeve includes at least one aperture row comprising a plurality of apertures, each of the plurality of apertures impinging a cooling flow jet onto the combustor liner; and
a plurality of flow redirecting components disposed proximate an aft end of the flow sleeve, wherein the plurality of flow redirecting components divert an impingement cross-flow flowing relatively perpendicular to the cooling flow jet, thereby providing the cooling flow jet an undisturbed flow path to the combustor liner.

2. The combustor liner cooling assembly of claim 1, wherein the at least one aperture row is disposed proximate the aft end of the flow sleeve, wherein the plurality of flow redirecting components are circumferentially aligned and disposed in circumferential alignment with the plurality of apertures of the at least one aperture row.

3. The combustor liner cooling assembly of claim 1, further comprising a forward sleeve disposed proximate the aft end of the flow sleeve and a forward end of an impingement sleeve, wherein the plurality of flow redirecting components are operably coupled to an inner surface of the forward sleeve.

4. The combustor liner cooling assembly of claim 1, further comprising an impingement sleeve disposed proximate the aft end of the flow sleeve, wherein the plurality of flow redirecting components are operably coupled to an inner surface of the impingement sleeve.

5. The combustor liner cooling assembly of claim 1, wherein the impingement cross-flow flows from a region defined by an impingement sleeve and a transition duct toward the aft end of the flow sleeve and into a region defined by the flow sleeve and the combustor liner.

6. The combustor liner cooling assembly of claim 1, wherein each of the plurality of flow redirecting components comprises a first portion of a semi-circular geometry.

7. The combustor liner cooling assembly of claim 6, wherein each of the plurality of flow redirecting components comprises at least one hole.

8. The combustor liner cooling assembly of claim 6, wherein each of the plurality of flow redirecting components further comprises a second portion extending axially from at least one end of the first portion.

9. The combustor liner cooling assembly of claim 1, wherein each of the plurality of flow redirecting components comprises a first portion of a triangular geometry.

10. The combustor liner cooling assembly of claim 9, wherein each of the plurality of flow redirecting components comprises at least one hole.

11. The combustor liner cooling assembly of claim 9, wherein each of the plurality of flow redirecting components further comprises a second portion extending axially from at least one end of the first portion.

12. A combustor liner cooling assembly for a gas turbine system comprising:
a combustor liner defining a combustor chamber;
a flow sleeve surrounding at least a portion of the combustor liner and having an aft end, wherein the flow sleeve includes a plurality of apertures for impinging a plurality of cooling flow jets onto the combustor liner;
an impingement sleeve disposed proximate the aft end of the flow sleeve, wherein an impingement flow path is defined by the impingement sleeve and a transition duct, wherein an impingement cross-flow flows through the impingement flow path into a region between the flow sleeve and the combustor liner; and
a plurality of flow redirecting components disposed proximate the aft end of the flow sleeve, wherein the plurality of flow redirecting components divert the impingement cross-flow.

13. The combustor liner cooling assembly of claim 12, wherein the plurality of apertures comprises a first aperture row, wherein the plurality of flow redirecting components are circumferentially aligned and disposed in circumferential alignment with the plurality of apertures of the first aperture row.

14. The combustor liner cooling assembly of claim 12, further comprising a forward sleeve disposed proximate the aft end of the flow sleeve and a forward end of the impingement sleeve, wherein the plurality of flow redirecting components are operably coupled to an inner surface of the forward sleeve.

15. The combustor liner cooling assembly of claim 12, wherein the plurality of flow redirecting components are operably coupled to an inner surface of the impingement sleeve.

16. The combustor liner cooling assembly of claim 12, wherein each of the plurality of flow redirecting components comprises a semi-circular geometry having a flow redirecting surface arranged to divert the impingement cross-flow.

17. The combustor liner cooling assembly of claim 12, wherein each of the plurality of flow redirecting components comprises a triangular geometry having a flow redirecting peak arranged to divert the impingement cross-flow.

18. A combustor liner cooling assembly for a gas turbine system comprising:
a combustor liner defining a combustor chamber;
a flow sleeve surrounding at least a portion of the combustor liner and having an aft end, wherein the flow sleeve includes a plurality of aperture rows, wherein each of the plurality of aperture rows comprises a plurality of apertures extending circumferentially around the flow sleeve, wherein each of the plurality of apertures impinges a cooling flow jet onto the combustor liner; and
a plurality of flow redirecting components disposed on a forward sleeve located proximate the aft end of the flow sleeve and a forward end of an impingement sleeve, wherein each of the plurality of flow redirecting components is circumferentially aligned with a corresponding first row aperture for diverting an impingement cross-flow entering a region between the flow sleeve and the combustor liner proximate the aft end of the flow sleeve.

19. The combustor liner cooling assembly of claim 18, wherein at least one of the plurality of flow redirecting components comprises a semi-circular geometry having a flow redirecting surface arranged to divert the impingement cross-flow.

20. The combustor liner cooling assembly of claim 18, wherein at least one of the plurality of flow redirecting components comprises a triangular geometry having a flow redirecting peak arranged to divert the impingement cross-flow.
